(19) United States
(12) Patent Application Publication
(10) Pub. No.: US 2013/0062081 A1
(43) Pub. Date: Mar. 14, 2013

(54) GARDEN TOOL

(71) Applicants: Gerald Rudy Gerent, Vista, CA (US); Joseph Scott Vermilyea, Big Bend, CA (US)

(72) Inventors: Gerald Rudy Gerent, Vista, CA (US); Joseph Scott Vermilyea, Big Bend, CA (US)

(21) Appl. No.: 13/610,556

(22) Filed: Sep. 11, 2012

Related U.S. Application Data
(60) Provisional application No. 61/533,633, filed on Sep. 12, 2011.
(60) Provisional application No. 61/545,479, filed on Oct. 10, 2011.

(51) Int. Cl. A01B 1/22; A01B 1/16

(52) U.S. Cl. 172/378; 172/371; 172/381

(57) ABSTRACT

In various embodiments, a garden tool may include a handle, a blade and mechanism for securing the handle to the blade. In various embodiments, the mechanism may include a first portion, in some cases a first band, configured to securely receive the handle. In various embodiments, the mechanism may include a second portion, in some cases a second band, defining a channel to surround a span of the handle. In various embodiments, the channel may be wider than a width of the handle along the span. This may permit movement of the handle relative to the blade during operation of the garden tool.

### CROSS REFERENCE TO RELATED APPLICATIONS

The present application claims priority to U.S. Provisional Patent Application Nos. 61/533,633, filed Sep. 12, 2011, and 61/545,479, filed Oct. 10, 2011, both entitled “Garden Tool,” the entire disclosures of which are hereby incorporated by reference in their entireties.

### TECHNICAL FIELD

Embodiments of the present invention relate to garden tools and methods of using garden tools.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Removing undesired plant life (also referred to as “weeds”) from a garden may be labor-intensive. If the root structure of the weed is not pulled along with the portion of the weed that is visible above-ground, the weed may grow back. However, in order to ensure that the root structure is removed, it may be necessary to loosen soil around the root structure so that it may be removed along with the weed. Additionally, removing weeds may be difficult because even with tools, the user may be required to bend over so that they can access the root structure. Extended periods of time spent bent over the ground removing weeds may lead to discomfort or even injury.

### BRIEF DESCRIPTION OF THE DRAWINGS

Embodiments of the present disclosure will be readily understood by the following detailed description in conjunction with the accompanying drawings. To facilitate this description, like reference numerals designate like structural elements. Embodiments of the disclosure are illustrated by way of example and not by way of limitation in the figures of the accompanying drawings.

FIG. 1 is a perspective view of an example garden tool, in accordance with various embodiments.

FIG. 2 is a perspective view of a garden tool blade, in accordance with various embodiments.

FIG. 3 is a front view of the garden tool blade of FIG. 2, in accordance with various embodiments.

FIG. 4 is a side view of the garden tool blade of FIGS. 2-3, in accordance with various embodiments.

### DETAILED DESCRIPTION OF VARIOUS EMBODIMENTS

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present disclosure. Therefore, the following detailed description is not to be taken in a limiting sense.

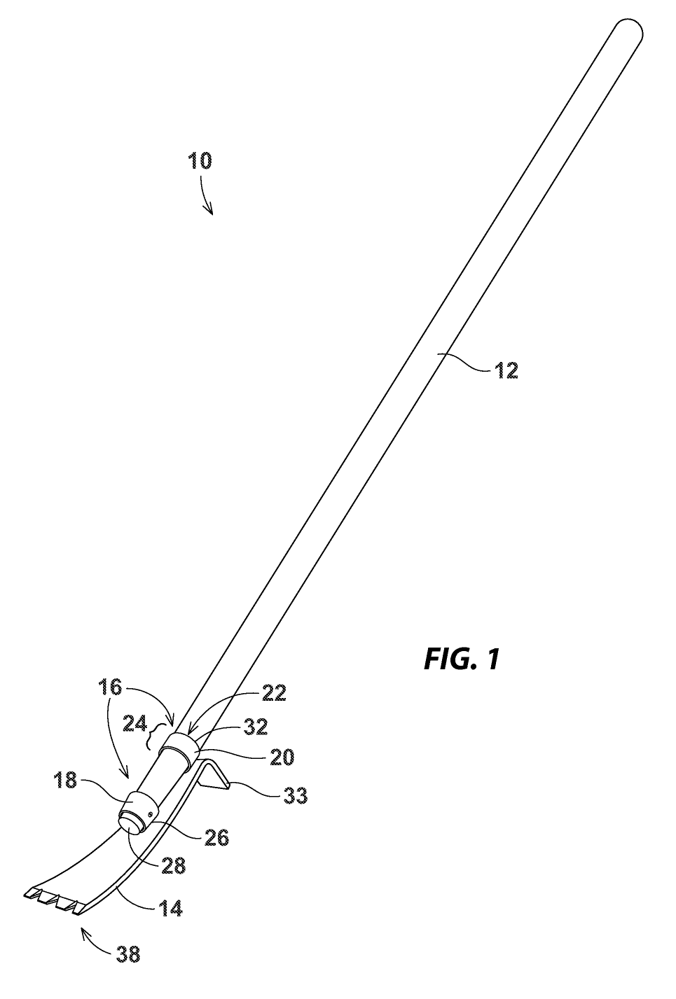

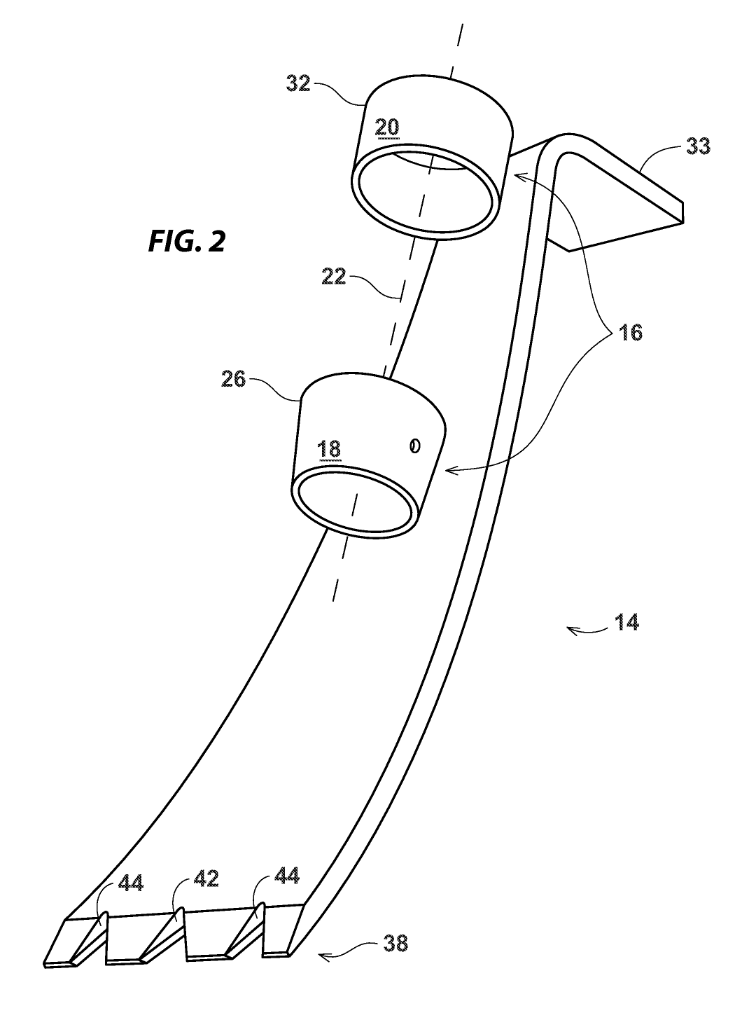

Referring now to FIGS. 1-4, a garden tool 10 may include a handle 12, a blade 14 and a mechanism 16 for securing handle 12 to blade 14. In various embodiments, handle 12 may be constructed from various materials, such as wood, plastic, metal, and so forth. In various embodiments, handle 12 may be of suitable length so that a user that uses garden tool 10 to remove a weed may be able to do so standing up, rather than while bending, kneeling or otherwise moving closer to the ground. In various embodiments, mechanism 16 may include a first portion 18 configured to securely receive handle 12 and a second portion 20 defining a channel 22 to surround a span 24 of handle 12. In various embodiments, channel 22 may have an internal diameter that is greater than a width of handle 12 along span 24. This may permit limited movement of handle 12 relative to blade 14 during operation of garden tool 10.

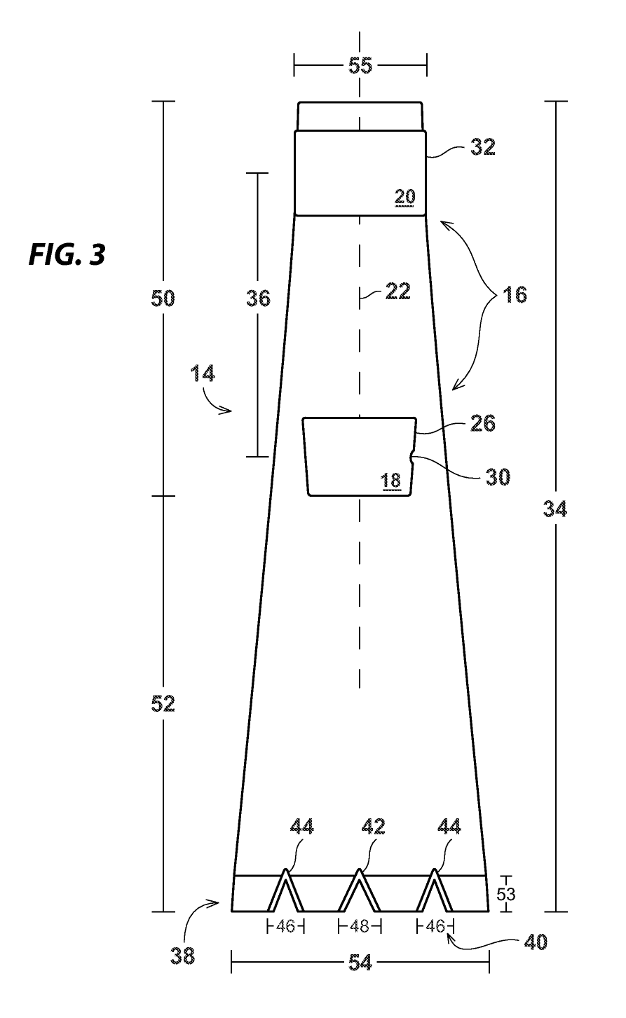

In various embodiments, first portion 18 may be a first band 26 (sometimes referred to as a “hosel”) configured to securely receive an end 28 of handle 12. In various embodiments, and as best seen in FIG. 3, an internal diameter of first band 26 may decrease along a length of first band 26 in a direction parallel to channel 22. In various embodiments, first portion 18 may include means for securing handle 12, such as an aperture 30 through which a screw or other fastener (not shown) may be inserted to penetrate into or otherwise secure handle 12. In various embodiments, handle 12 may be constructed of material that is less hard than first band 26, such as wood. In such cases, handle 12 may be forced into first band 26 so that first band 26 slightly compresses handle 12, thereby securing handle 12 therein without the use of a fastener.

In various embodiments, second portion 20 may be a second band 32. In various embodiments, second band 32 may be substantially concentric with first band 26. In various embodiments, second band 32 may have an internal diameter than is greater than a diameter of span 24 of handle 12. As noted above, this may permit limited movement of handle 12 relative to blade 14, which may distribute stress over more of garden tool 10, particularly over more of blade 14. If only first band 26 were used, a majority of the stress would be at that forward point of attachment. In various embodiments, second band 32 may have a uniform internal diameter along its entire length, though this is not required.

Blade 14 may be constructed of various materials, usually metals. For instance, in some embodiments, blade 14 may include armor plated steel. In various embodiments, blade 14 may include a heel 33 extending substantially perpendicular to a longitudinal axis of channel 22. Heel 33 may be used for various purposes. Some users may step on heel 33 when using garden tool 10 to penetrate soil, e.g., to provide additional force beyond that provided by the user's arms. In various embodiments, heel 33 protrudes outwards a length that is sufficient for a user to step on it, e.g., for digging and rooting.

Referring now to FIG. 3, in various embodiments, blade 14 may have a height 34. In some embodiments, height 34 may be approximately ten inches. In various embodiments, first portion 18 may be separated from second portion 20 by a second distance 36. In various embodiments, a ratio of height 34 to second distance 36 may be approximately 3:1.

In various embodiments, blade 14 may include a tapered tip 38 extending perpendicular to a longitudinal axis of channel 22. In various embodiments, the tapered tip 38 may terminate in a sharp edge. In various embodiments, the sharp edge may be sharpened sufficiently to cut surface weeds. In various embodiments, blade 14 may have a thickness of approximately 3/16 inch, and tapered end 38 may taper down, e.g., over a distance of approximately one inch, to a thickness of approximately 1/16 inch.

In various embodiments, tapered tip 38 may include at least one vegetation capture recess 40. In various embodiments, vegetation capture recesses 40 may be between about 0.25 inches and about 0.75 inches deep. The embodiment of FIGS. 1-4 includes three vegetation capture recesses 40: a middle vegetation capture recess 42 and two flanking vegetation capture recesses 44. In various embodiments, and as seen in FIG. 3, middle vegetation capture recess 42 may be slightly wider than flanking vegetation capture recesses 44. For instance, in one embodiment, flanking vegetation capture recesses 44 may have widths 46 of approximately a quarter inch, whereas middle vegetation capture recess 42 may have a width 48 of approximately ⅜ inches. In another embodiment, flanking vegetation capture recesses 44 may have widths 46 of approximately ⅜ inches, whereas middle vegetation capture recess 42 may have a width 48 of approximately one half inch.

In some embodiments (not shown), flanking vegetation capture recesses 44 may be shallower than middle vegetation capture recess 42. For example, in one embodiment, flanking vegetation capture recesses 44 may be approximately ¾ inch deep, whereas middle vegetation capture recess 42 may be approximately one inch deep. In various embodiments, an apex of each flanking vegetation capture recess 44 may be approximately ½ inch away from a side of blade 14, and the apex of middle vegetation capture recess 42 may be approximately an inch and a half from the side of blade 14.

In various embodiments, vegetation capture recesses 40 may be shaped to capture underground vegetation roots without cutting them. This may facilitate removal of the entire plant, rather than just the part above the root, so that the plant does not grow back. In order to prevent vegetation capture recesses 40 from cutting the root, in some embodiments, vegetation capture recesses 40 may be less sharp than tapered tip 38. In various embodiments, vegetation capture recesses 40 may have tapered inner portions that facilitate movement of vegetation capture recesses 40 to a position immediately adjacent a root structure.

In various embodiments, garden tool 10 may be used to remove a root structure as follows. Garden tool 10 may be operated so that blade 14 is inserted into the ground, adjacent the weed, so that middle vegetation capture recess 42 is aligned with the root. Once the tip of blade is sufficiently underground, handle 12 may be pulled back, pivoting garden tool 10 using the ground as a fulcrum, to extract the root.

Blade 14 may have various other dimensions as well. For instance, in some embodiments, a ratio between height 34 and a distance 50 between a top of blade 14 and a bottom of first portion 18 may be approximately 10:4.5. In some embodiments, a ratio between height 34 and a distance 52 between a bottom of bottom of first portion 18 and a bottom of blade 14 may be 10:5.5. In various embodiments, tapered tip 38 of blade 14 may have a length 53. In various embodiments, length 53 may be approximately a half inch. In various embodiments, a ratio between a width 54 of blade 14 at its bottom and a width 55 of blade 14 at its top may be approximately 2:1. In various embodiments, width 54 may be approximately three inches, and/or width 55 may be approximately 1.5 inches.

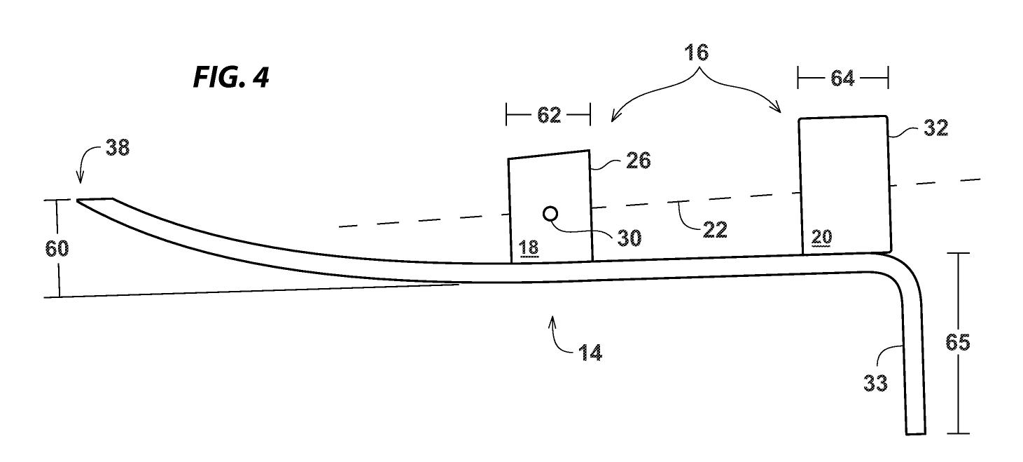

Referring now to FIG. 4, in various embodiments, blade 14 may curve across a longitudinal axis of channel 22. For instance, blade 14 may curve across channel 22 so that tapered tip 38 is curved away from an upper portion of blade 14, e.g., by a distance 60 of between 1 and 2 inches. This shovel-shaped curve may facilitate weeding while in an upright position. It may also facilitate capture of roots deep underground, as well as planting of new vegetation. The curvature allows this work to be less physically demanding than it might be using other conventional tools.

In various embodiments, first band 26 and second band 32 may have heights 62 and 64, respectively, that are approximately equal to each other. For instance, heights 62 and 64 may be approximately one inch. In various embodiments, a ratio of height 34 (FIG. 3) to a length 65 of heel 33 may be approximately 5:1. In various embodiments, length 65 may be about two inches.

Garden tool 10 may be used for other purposes other than those described above. For example, garden tool 10 may be used vertically to cut sod to a desired depth. Garden tool 10 may then be used as a shuttle hoe to sever the sod from the underlying soil. Garden tool 10 may also be used for planting. For instance, blade 14 may be used to loosen dirt for removal, and may also be used as a shovel assuming the amount of dirt to remove is not too great. Garden tool 10 may also be used for transplanting. Blade 14 (with or without handle 12 attached) may be used to cut around root structure, and then may be inserted underneath so that blade 14 may be used to pry up the whole plant. Garden tool may be used outside of the garden as well. For instance, garden tool 10 may be used in paving and rock work to wedge and/or pry rocks from structures, etc.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein.

What is claimed is:

1. A garden tool comprising a handle, a blade and mechanism for securing the handle to the blade, the mechanism including a first portion configured to securely receive the handle and a second portion defining a channel to surround a span of the handle, the channel being wider than a width of the handle along the span to permit movement of the handle relative to the blade during operation of the garden tool.

2. The garden tool of claim 1, wherein the first portion comprises a first band configured to securely receive an end of the handle and the second portion comprises a second band substantially concentric with the first band.

3. The garden tool of claim 2, wherein a diameter of the first band decreases along a length of the first band in a direction parallel to the channel.

4. The garden tool of claim 2, wherein the first band includes a fastener for securing the handle to the blade.

5. The garden tool of claim 1, wherein the garden tool has a height, measured parallel to the channel, of a first distance, the first portion is separated from the second portion by a second distance, and a ratio of the first distance to the second distance is approximately 3:1.

6. The garden tool of claim 1, wherein the second band has a diameter that is greater than a diameter of the span of the handle.

7. The garden tool of claim 1, further comprising a heel extending substantially perpendicular to a longitudinal axis of the channel.

8. The garden tool of claim 1, wherein the blade curves across a longitudinal axis of the channel.

9. The garden tool of claim 8, wherein a tip of the blade is curved away from an upper portion of the blade by between one and two inches.

10. The garden tool of claim 1, wherein the blade includes a tapered tip with at least one vegetation capture recess.

11. The garden tool of claim 10, wherein the at least one vegetation capture recess is between about 0.25 inches and about 0.75 inches deep.

12. The garden tool of claim 10, wherein the at least one vegetation capture recess comprises at least three vegetation capture recesses including a middle vegetation capture recess and two flanking vegetation capture recesses that are shallower than the middle vegetation capture recess.

13. A garden tool blade, comprising:
a blade portion;
a first band configured to receive a handle and to permit movement of the handle within the first band during operation of the garden tool; and
a second band substantially concentric with the first band to securely receive an end of the handle.

14. The garden tool blade of claim 14, wherein a diameter of the second band decreases along a length of the second band in a direction parallel to a longitudinal axis defined by the first and second bands.

15. The garden tool blade of claim 13, wherein the blade portion includes a sharp end with at least one vegetation capture recess.

16. The garden tool blade of claim 15, wherein the at least one vegetation capture recess is between about 0.25 inches and about 0.75 inches deep.

17. The garden tool blade of claim 15, wherein the at least one vegetation capture recess comprises at least three vegetation capture recesses including a middle vegetation capture recess and two flanking vegetation capture recesses that are shallower than the middle vegetation capture recess.

18. The garden tool blade of claim 13, wherein the blade portion has a height, measured parallel to a channel defined by the first and second bands, of a first distance, the first band is separated from the second band by a second distance, and a ratio of the first distance to the second distance is approximately 3:1.
